(19) United States
(12) Patent Application Publication
(10) Pub. No.: US 2004/0211768 A1
(43) Pub. Date: Oct. 28, 2004

(54) Control circuit for a dental handpiece

(76) Inventor: Gerhard Schmid, Mittelbiberach (DE)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/780,272

(22) Filed: Feb. 17, 2004

(30) Foreign Application Priority Data
Feb. 18, 2003 (DE) 103 06 798.1

(51) Int. Cl. H05B 3/02; A61C 3/00

(52) U.S. Cl. 219/489; 433/32

(57) ABSTRACT

A control circuit for control of a media heating device of a dental handpiece has a heating current circuit in which there is arranged a switch which can be actuated by hand, for the activation of the heating device. In order to be able to purposively deactivate the heating device, a further controllable switch element is arranged in the heating current circuit, which switch element can be set in dependence upon an external control signal into a conducting or non-conducting condition.

The present invention relates to a control circuit for a dental handpiece in accordance with the preamble of claim 1. In particular, the invention relates relates to a control circuit for controlling a heating device of a dental handpiece.

Dental handpieces often have media lines for air and water which open up the possibility of cleaning and drying the site be treated, or the just treated site, in the mouth of the patient with air and/or water. So-called spray handpieces are provided exclusively for directing air or water to particular sites. Such a dental spray handpiece is known for example from DE 195 39 534 A1 of the present applicant.

As a rule, dental handpieces of the kind mentioned above offer beyond this also the possibility of heating the media to be issued to body temperature, in order to bring about in the patient, in whose mouth they are put to use, no reflex or defence reactions. For heating the media there are provided in the handpiece heating devices in the form of heating cartridges or heating coils arranged in the media lines, which are connected to a heating current circuit. This heating current circuit is connected with a switch, which can be activated by the user of the handpiece, in order to close the heating current circuit and therewith activate the heating device.

DE 195 39 534 A1 describes a possibility of automatically activating the heating devices after actuation of the appropriate switches for the media valves. There is described a circuit arrangement which after an actuation of the switch generates a corresponding control signal for closing the heating current circuit. Beyond this, at the same time as the activation of the heating device, a lighting current circuit is closed and therewith a light source arranged in the handpiece switched on, which brings about an illumination of the region which the exit opening of the dental handpiece faces.

The known control circuit consists of relatively many individual components and is correspondingly relatively costly to produce. Beyond this, upon an actuation of the switch for the media valve, the corresponding media heating is also automatically activated, which although as a rule is desired during a dental treatment, in other situations—for example during an intensive disinfection or cleaning procedure, in which the media lines of the handpiece are rinsed through with a cleaning solution—is however rather considered as disadvantageous.

The present invention is thus based on the object of indicating an alternative solution for the control of a heating device of a dental handpiece, which should in particular distinguish itself through its simple structure. Beyond this there should be opened up the possibility of purposively deactivating the media heating in certain situations.

The object is achieved by means of a control circuit for the control of a media heating device of a dental handpiece which has the features of claim 1.

The control circuit in accordance with the invention has first a heating current circuit in which there is arranged a switch, which can be actuated by hand, for the activation of the heating device. In accordance with the invention, there is further arranged in the heating current circuit a further controllable switch element, which in dependence upon an external control signal can be set into a conducting or non-conducting condition.

The solution in accordance with the invention thus opens up the possibility of completely switching off the heating via an external control signal, so that even upon an actuation of the switch no warming of the media occurs. The heating can therewith be switched on or switched off via an external apparatus controller of the handpiece. In particular it can be switched off when the media lines are rinsed through with a cleaning fluid for cleaning purposes.

In accordance with an advantageous further development of the invention, the heating current circuit is connected to an a.c. voltage source, wherein along with the first controllable switch element a further switch element is provided and the two switch elements are arranged in the heating current circuit anti-parallel to one another. In particular, as the controllable switch elements, there may be involved thyristors, to which the external control signal is delivered via two optotriacs. This solution makes possible on the one hand a large current range for the heating current, on the other hand simple sensor components in the form of the optotriacs can be employed, so that the circuit arrangement can overall be kept very economical.

Advantageously, the heating current circuit has two heating devices, one for air and one for water, whereby each heating device has associated therewith its own switch, which can be actuated by hand. The switch may at the same time also be the switch for actuating the corresponding media valve, so that—presuming the external signal makes possible the flowing of a heating current—upon an actuation of the switch on the one hand the corresponding medium is issued and on the other at the same time the corresponding heating device is activated.

In accordance with an advantageous further development of the invention there is further provided an illumination device which upon an activation of at least one of the two media heaters is likewise activated. A corresponding input signal for switching on the light source can be obtained by means of a voltage drop within the heating current circuit, which is delivered to the illumination device via an opto-coupler. Preferably there is provided for the illumination device a control block which beyond this ensures that the illumination device further remains switched on for a predetermined persistence time even after a deactivation of the media heating.

Both the heating current circuit and also the illumination device may be connected to a common current supply source, whereby in the case that the current supply source delivers an a.c. voltage a rectifier is preferably connected upstream of the illumination device.

Below, the invention will be described in more detail with reference to the accompanying drawings. There is shown:

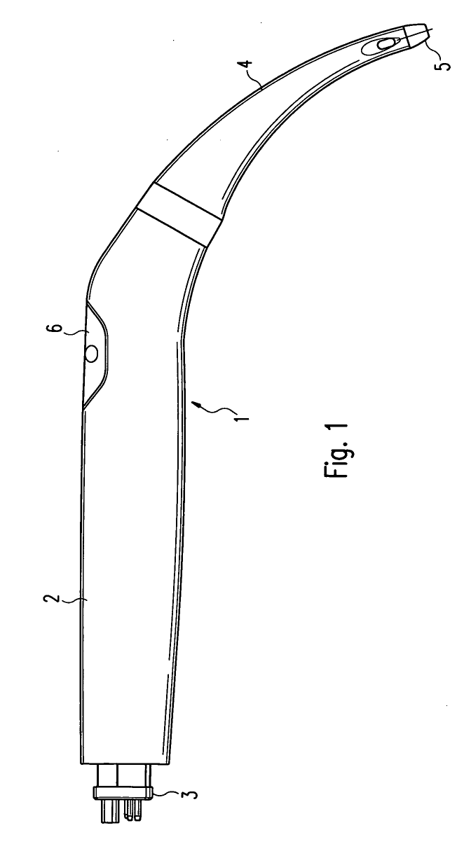

FIG. 1 a dental spray handpiece, with which the control circuit in accordance with the invention is to be put to use, in a side view;

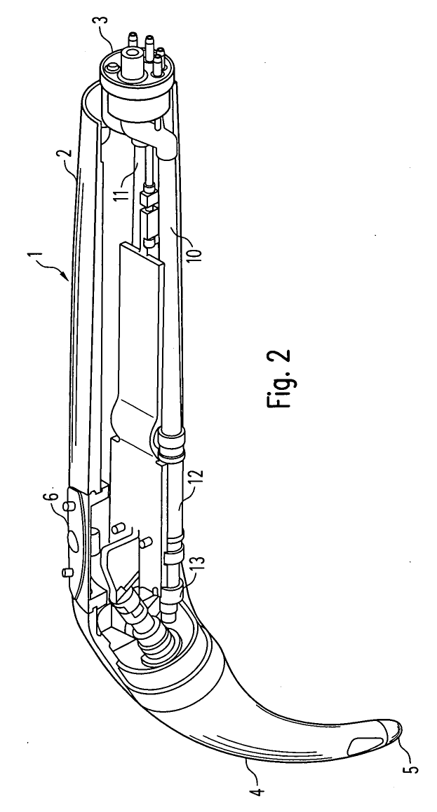

FIG. 2 the spray handpiece in a partial section;

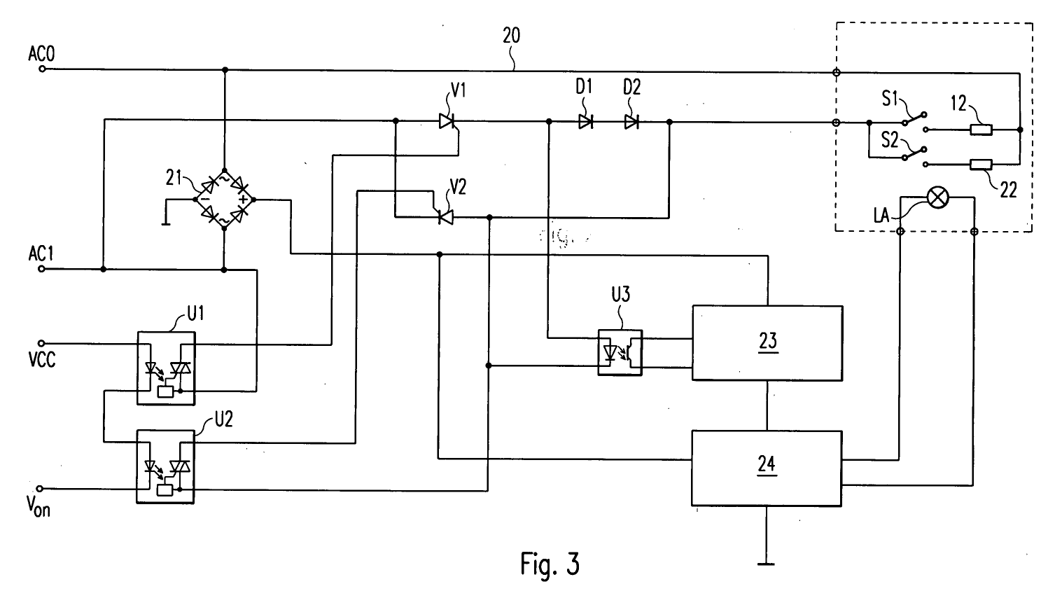

FIG. 3 a schematic illustration of the control circuit in accordance with the invention.

The dental spray handpiece 1 illustrated in FIG. 1 is of an elongate grip body 2, to the rear side of which there is arranged a media coupling 3, via which the handpiece 1 can be connected to a conventional supply hose of a dental treatment station. The media coupling 3 has for this purpose individual connection parts for the media air and water, and further supply lines for current and light.

At the forward end of the grip body 2 there is arranged a bowed nozzle body 4, at the free end of which a nozzle 5 for issuing air and/or water is located. In the case that air and water are to be issued at the same time, the handpiece is operated in so-called spray mode. As will be explained below, beyond this the nozzle body 4 makes it possible to direct light onto the site to be treated.

In the forward region of the elongate grip body 2 there is located, on its upper side, a key field 6 having two actuation elements for the media air and water. Via the two actuation elements in each case the valve for the corresponding media line can be opened and at the same time a switch for the activation of the corresponding media heating closed. Upon a simultaneous activation of both actuating elements, the media lines for air and water are simultaneously opened, so that air and water are issued, with the aid of the nozzle 5 arranged at the forward end of the nozzle body 4, in the form of a spray. The handpiece is then in the above-mentioned spray mode.

FIG. 2 shows a considerable part of the elements arranged within the handpiece 1. For reasons of clarity, there are not illustrated the switch levers, which can be activated via the key field 6, for opening the media lines and switching on the media heating, and also the electronic components of the control circuit for the heating device which are explained further below.

Within the grip body 2, the two media lines 10 and 11 for air and water, which at their rearward ends are connected with the corresponding connecting parts of the media coupling 3, run in longitudinal direction. In the forward region of the media line 10 for air there is located a heating element 12 with the aid of which the air flowing through the media line 10 is heated. In the case of this heating element there is involved a conventional heating cartridge, which continues the media line 10, so that the air is heated upon flowing through the heating cartridge 12. In similar manner there is also provided a corresponding heating element for the media line 11 for water.

At the forward end of the elongate grip body 2 there is further located a holder 13 for mounting a light source. In the case of this light source, there is involved an incandescent lamp which after its switching on radiates light into the bowed nozzle body 4 which is carried further via appropriate light directing means—for example a glass fibre bundle or the like—to the nozzle 5. The light rays issued by the light source are thus directed towards the same site as the air and/or water, so that the site targeted via the nozzle 5 can be optimally observed by the user of the handpiece.

During a dental treatment, simultaneously with the opening of the media line, there is thus activated the corresponding heating element, in order to heat the medium approximately to body temperature. This automatic heating is as rule desired in order to bring about no reflex or defence reactions in the patient into whose mouth the medium or media are sprayed. On the other hand, in particular cases, despite opening of the media valve the heating should deliberately remain switched off. This is made possible by means of the control circuit in accordance with the invention which is to be described below with reference to FIG. 3.

A main component of the control circuit is a heating current circuit 20 which is connected with its two terminals to a current supply source AC0, AC1. This delivers an a.c. voltage of preferably 24V. There is arranged in the heating circuit 20 a parallel circuit of two heating elements 12 and 22 for air and water—schematically represented as resistors—whereby there is arranged in series to each heating element 12 and 22 in each case a switch S1 and S2, which upon an actuation of the corresponding key field at the handpiece upper side is closed simultaneously with the opening of the corresponding media valve.

In order to open up the possibility of the deactivating and switching on the heating via an external apparatus controller, there is further provided in the heating current circuit 20 a parallel connection of two thyristors V1 and V2 arranged anti-parallel, which can be selectively biased into a conducting or non-conducting condition. The anti-parallel arrangement of the two thyristors V1 and V2 is necessary since the heating current circuit 20 is supplied from an a.c. voltage source and a current flow through the heating elements 12 and 22 is to occur in both half-waves of the a.c. voltage.

The control of the two thyristors V1 and V2 is effected via an external control signal, generated by the apparatus controller, which is applied to two further terminals VCC and Vₒₙ of the control circuit. These external control signals are passed on to the two thyristors V1 and V2 in each case via an optotriac U1 or U2, so that upon application of a switch-on signal the thyristors V1 and V2 are switched on. If, in this condition, one of the two switches S1 or S2 for the two heating elements 12 and 22 is closed, current thus flows through the corresponding heating element 12, 22 and the corresponding medium, whose media valve is opened at the same time with the closing of the corresponding switch S1 or S2, is heated.

On the other hand, if a switch-off signal is set via the two inputs VCC and Vₒₙ, the two thyristors are in a non-conducting condition. If in this case one of the two key fields on the handpiece upper side is actuated, although the corresponding media valve is opened the associated heating element 12 or 22, however, remains deactivated, despite closing of the corresponding switch S1 or S2, since the two thyristors V1 and V2 do not make possible a current flow in the heating current circuit 20. This switching off of the media heating can in particular be provided when the media lines are to be rinsed through with a cleaning fluid for intensive disinfection. Further, also during a treatment, the media heating can be deliberately switched off, in order for example to test the reflexes of the patient.

Supplementing the two heating elements 12 and 22, there is further arranged in the circuitry a light source in the form of an incandescent lamp LA which likewise is to be switched on upon an actuation of the heating elements 12, 22. For this purpose there is provided a control block 23 which generates corresponding control signals for light supply unit 24 for operating the incandescent lamp LA. The input signal for the control block 23 is generated by means of a voltage drop within the heating current circuit 20, which arises in the case of the switching on of one of the two switches S1 and S2. In the illustrated example, the voltage drop across two diodes D1 and D2 is employed, which are arranged in the parallel branch of one of the two thyristors V1, V2.

The voltage drop across the two diodes D1 and D2 is passed on via an opto-coupler U3 so that there is delivered to the control block 23, when a heating current is flowing, a square-wave signal corresponding to the frequency of the a.c. voltage. This square-wave signal is interpreted by the control block 23 as a start signal for the activation of the lamp LA, which block in response passes on a corresponding control signal to the light supply device 24 which then delivers a corresponding current to the incandescent lamp LA.

The control block 23 for the light supply has further a timing member, which after a switching off of the heating elements 12 and 22 generates further a switch-on signal for the light supply unit 24, for a certain persistence time.

Through this it is ensured that also after a switching off of the two media, the light continues for a certain persistence time and the site just treated can be observed.

The current supply of the various components for the illumination device is likewise effected via the current supply terminals AC0 and AC1 of the heating current circuit 20, whereby however, a rectifier 21 is arranged upstream of the light supply unit. The diodes D1 and D2 constitute in this case very simple sensor components for the activation of the light supply, through which additionally the construction cost for the control circuit in accordance with the invention can be reduced. Since, further, they are active only in one half-wave of the supply a.c. voltage, there occur with the circuitry arrangement in accordance with the invention very low power losses.

The present circuitry arrangement thus makes possible a large current range for the two heating elements. Since, further, simple sensor components in the form of the two optotriacs and diodes are employed, the circuitry can also be produced economically. Further there is opened up the possibility of purposively deactivating the media heating.

1. Control circuit for control of a media heating device of a dental handpiece, comprising
a heating current circuit in which there is arranged at least one hand-actuatable switch, which can be actuated by hand, for activating the heating device; and,
at least one further, controllable switch element arranged in the heating current circuit, which switch element can be set in dependence upon an external control signal into a conducting condition or a non-conducting condition.

2. Control circuit according to claim 1,
wherein
the heating current circuit is connected to an a.c. voltage source and there are provided two controllable switch elements which are arranged anti-parallel in the heating current circuit.

3. Control circuit according to claim 1, comprising one or two optotriacs to deliver the external control signal to the controllable switch element.

4. Control circuit according to claim 1,
wherein
the controllable switch element is a thyristor.

5. Control circuit according to claim 1,
wherein
two hand-actuatable switches are arranged in the heating current circuit in parallel to one another, one said switch being provided for activating air media heating and another said switch being provided for activating water media heating.

6. Control circuit according to claim 1,
comprising a valve for a corresponding air or water medium opened
upon actuation of each said switch.

7. Control circuit according to claim 1,
further comprising an illumination device for the dental handpiece, which is activated upon activation of the heating device.

8. Control circuit according to claim 7,
wherein the illumination device remains active for a predetermined persistence time after deactivation of the heating device.

9. Control circuit according to claim 7,
wherein
the illumination device comprises a control block, which, in dependence upon an input signal, controls a light supply unit for operating a light source.

10. Control circuit according to claim 9,
wherein a voltage drop within the heating current circuit is delivered to the control block as an input signal.

11. Control circuit according to claim 10,
wherein
the voltage drop within the heating current circuit is delivered to the control block via an opto-coupler.

12. Control circuit according to claim 7,
wherein
the heating current circuit and the illumination device are connected to a common current supply source.

13. Control circuit according to claim 12,
wherein
the current supply source issues an a.c. voltage, with a rectifier connected upstream of the illumination device.

14. Dental handpiece having a heating device for heating at least one of an air supply and a water supply,
comprising
a control circuit in accordance with claim 1.

15. Dental handpiece according to claim 14,
comprising a dental spray handpiece.

16. Dental spray handpiece comprising a heating device which can be switched on and switched off, for
a medium flowing therethrough, wherein
the heating device can be deactivated when the medium is intended for the purpose of at least one of cleaning and disinfecting the spray handpiece.

17. Dental spray handpiece according to claim 16,
wherein
the heating device can be deactivated via an external signal.
